(19) United States
(12) Patent Application Publication
(10) Pub. No.: US 2025/0222606 A1
(43) Pub. Date: Jul. 10, 2025

(54) ANTI-LOOSE MOUNTING STRUCTURE OF ELECTRIC HAIR CUTTER FIXED BLADE MOUNTING FRAME

(71) Applicant: NINGBO ICLIPPER ELECTRIC APPLIANCE CO.,LTD, Ningbo (CN)

(72) Inventor: Haoze WU, Ningbo (CN)

(21) Appl. No.: 18/919,456

(22) Filed: Oct. 18, 2024

(30) Foreign Application Priority Data
Jan. 9, 2024 (CN) 2024200503391

(51) Int. Cl. B26B 19/38; B26B 19/04

(52) U.S. Cl. CPC B26B 19/386; B26B 19/04

(57) ABSTRACT

An anti-loose mounting structure of an electric hair cutter fixed blade mounting frame comprising a body and a cutter head assembly; the cutter head assembly is arranged at a front end of the body, and the cutter head assembly further comprises a fixed blade mounting frame and a fixed blade; the fixed blade is fixedly connected to the fixed blade mounting frame, the front end of the body is provided with a guide rail, and the fixed blade mounting frame is slidably connected to the guide rail; an elastic member is arranged between the guide rail and the fixed blade mounting frame, and the fixed blade mounting frame is always tightly attached to an inner side wall of the guide rail; the fixed blade mounting frame operates stably, making the entire cutter head assembly operate smoothly such that the operating performance of the electric hair cutter is significantly enhanced.

### TECHNICAL FIELD

This invention generally relates to the technical field of electric hair cutters, and more particularly, to an anti-loose mounting structure of an electric hair cutter fixed blade mounting frame.

### BACKGROUND

With the fast growth of the hairdressing industry, the demand for hair cutters has increased rapidly. Presently, the market demands high-quality and easy-to-use hair cutters. A conventional hair cutter comprises a hair cutter body, wherein guide rails are respectively arranged on two sides of the top end of the body, a fixed blade mounting frame is slidably arranged on the guide rail, and the fixed blade mounting frame is capable of sliding on the guide rail. A fixed blade is further fixedly connected to the top of the fixed blade mounting frame by means of a screw, and an adjusting wrench is rotatably arranged on one side of the fixed blade mounting frame. The fixed blade mounting frame is controlled to move relative to the guide rail through adjusting the wrench, thereby changing the front and rear positions of the fixed blade such that the cut length of hair is effectively controlled.

Chinese patent CN213106940U discloses a shift adjustment mechanism and an electric hair cutter, comprising a hair cutter body, wherein a guide rail is arranged at the top end of the hair cutter body, and a lower cutter holder (i.e., a fixed blade mounting frame) is slidably mounted on the guide rail. The top of the lower cutter holder is connected with a fixed blade, one side of the hair cutter body is provided with an adjusting wrench, and the adjusting wrench is capable of rotating relative to the lower cutter holder and pushing the lower cutter holder to slide along the guide rail. By rotating the adjusting wrench, a shift lever rotates along with the adjusting wrench, and because the moving path of the shift lever is not an arc shape, a push rod connected to the adjusting wrench pushes the lower cutter holder to move back and forth when the adjusting wrench rotates. Therefore, the fixed blade fixedly connected to the lower cutter holder moves back and forth to change the front-back distance between the fixed blade and a movable blade, thereby achieving the effect of controlling the cut length of hair.

However, in the aforesaid technical solution, due to the dimensional tolerance inevitably generated between the guide rail and the lower cutter holder at the top end of the hair cutter body during production, when the lower cutter holder is mounted to the guide rail, a gap is easily generated between the lower cutter holder and the inner wall of the guide rail, resulting in the shaking of the lower cutter holder and unstable operation of the entire cutter head assembly. In use, phenomenons such as loosening and tightening of the lower cutter holder as well as noise may occur, severely affecting the operating performance of the electric hair cutter.

Therefore, it is urgent for those skilled in the art to solve the prior technical problem.

### SUMMARY

The purpose of the present invention is to provide an anti-loose mounting structure of an electric hair cutter fixed blade mounting frame. Through arranging an elastic member between the fixed blade mounting frame and the guide rail, the fixed blade mounting frame operates stably, thus achieving the stable operation of the entire cutter head assembly while avoiding loosening and tightening of the cutter head assembly as well as noise generated during use.

To achieve the above purpose, the present invention adopts the following technical solution: an anti-loose mounting structure of an electric hair cutter fixed blade mounting frame comprises a body and a cutter head assembly, wherein the cutter head assembly is arranged at a front end of the body, and the cutter head assembly further comprises a fixed blade mounting frame and a fixed blade, wherein the fixed blade is fixedly connected to the fixed blade mounting frame, the front end of the body is provided with a guide rail, and the fixed blade mounting frame is slidably connected to the guide rail.

In another embodiment of the present invention, an elastic member is arranged between the guide rail and the fixed blade mounting frame, and the elastic member always imposes an elastic force on the fixed blade mounting frame. The direction of the elastic force is perpendicular to the sliding direction of the fixed blade mounting frame along the guide rail, so that the fixed blade mounting frame is always tightly attached to an inner side wall of the guide rail. The fixed blade mounting frame is provided with a bent portion extending inwards, the fixed blade mounting frame interacts with the guide rail in a sliding manner through the bent portion, and the elastic member abuts between the bent portion and the guide rail.

In another embodiment of the present invention, the elastic member is an arched elastic sheet.

In another embodiment of the present invention, the arched elastic sheet is provided with an arched portion, and both ends of the arched portion extend to form a flat abutting portion. The arched portion abuts against the fixed blade mounting frame, and the flat abutting portion abuts against the inner side wall of the guide rail.

In another embodiment of the present invention, the inner side wall of the guide rail is provided with a groove for interacting with the arched elastic sheet, and the arched elastic sheet is installed in the groove by means of the flat abutting portion.

In another embodiment of the present invention, the length of the groove is greater than the length of the arched elastic sheet, and the depth of the groove is lower than the height of the arched elastic sheet.

In another embodiment of the present invention, one side of the body is provided with an adjusting wrench for propelling the fixed blade mounting frame to slide relative to the guide rail, and an elastic member is arranged on the other side of the body corresponding to the adjusting wrench.

In another embodiment of the present invention, the elastic member is made of a spring steel material.

Compared with the prior art, the present invention has the following advantages: the anti-loose mounting structure of the electric hair cutter fixed blade mounting frame comprises a body and a cutter head assembly, wherein the cutter head assembly is arranged at a front end of the body, and the cutter head assembly further comprises a fixed blade mounting frame and a fixed blade; the fixed blade is fixedly connected to the fixed blade mounting frame, the front end of the body is provided with a guide rail, and the fixed blade mounting frame is slidably connected to the guide rail; an elastic member is arranged between the guide rail and the fixed blade mounting frame, and the elastic member always imposes an elastic force on the fixed blade mounting frame; the direction of the elastic force is perpendicular to the sliding direction of the fixed blade mounting frame along the guide rail, so that the fixed blade mounting frame is always tightly attached to an inner side wall of the guide rail; the elastic member is an arched elastic sheet; through arranging the elastic member between the fixed blade mounting frame and the guide rail, the elastic member always imposes an elastic force on the fixed blade mounting frame; the direction of the elastic force is perpendicular to the sliding direction of the fixed blade mounting frame along the guide rail, so that the dimensional tolerance generated inevitably during production between the guide rail and the fixed blade mounting frame is compensated; in this way, when the fixed blade mounting frame is mounted to the guide rail, the fixed blade mounting frame is always tightly attached to the inner side wall of the guide rail, thereby preventing a gap from being generated between the fixed blade mounting frame and the inner wall of the guide rail; the fixed blade mounting frame operates stably, thus achieving the stable operation of the entire cutter head assembly while avoiding loosening and tightening of the cutter head assembly as well as noise generated during use; thus, the operating performance of the electric hair cutter is significantly improved.

### BRIEF DESCRIPTION OF THE DRAWINGS

To more clearly illustrate specific embodiments of the present invention, the drawings required in the description of the specific embodiments are briefly described below. Obviously, the drawings in the following description merely illustrate some embodiments of the present invention, and for those of skilled in the art, other drawings may be obtained according to these drawings without paying creative labor.

FIG. 1 is a schematic diagram illustrating an explosive view of the entire structure of the present invention;

FIG. 2 is a schematic diagram illustrating an enlarged structure of portion A in FIG. 1 of the present invention;

FIG. 3 is a schematic diagram illustrating a three-dimensional structure of the arched elastic sheet of the present invention;

FIG. 4 is a schematic diagram illustrating a partial structure of the body of the present invention;

FIG. 5 is a schematic diagram illustrating a three-dimensional structure of the fixed blade mounting frame of the present invention;

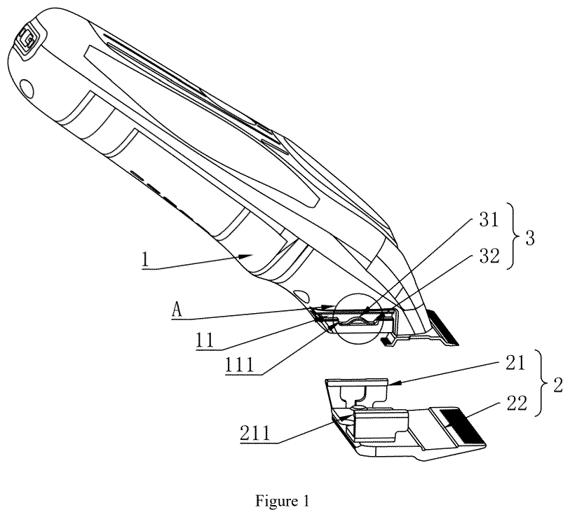

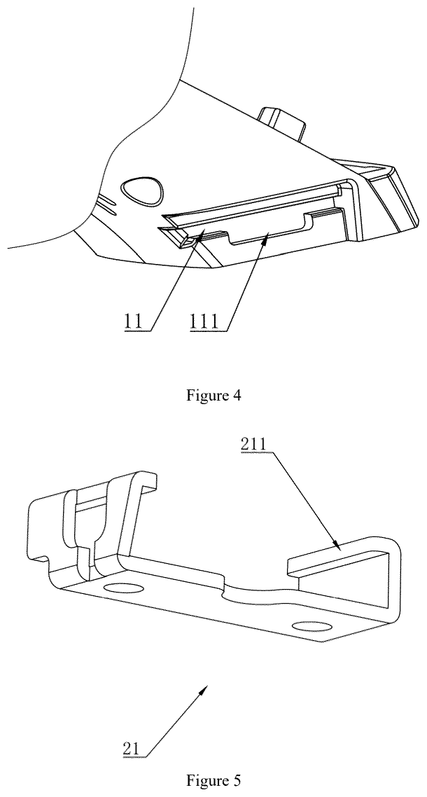

In FIGS. 1-5:
1—Body, 11—Guide Rail, 111—Groove, 2—Cutter Head Assembly, 21—Fixed Blade Mounting Frame, 211—Bent Portion, 222—Fixed Blade, 3—Arched Elastic Sheet, 31—Arched Portion, 32—Flat Abutting Portion.

### DETAILED DESCRIPTION

While specific embodiments of the invention have been described in detail, it will be appreciated by those skilled in the art that various modifications and alternatives to those details could be developed in light of the overall teachings of the present invention. Accordingly, the particular arrangements disclosed are meant to be illustrative only and not limiting as to the scope of the invention which is to be given the full breadth of the claims appended and any and all equivalents thereof.

In the description of the present invention, it should be understood that the orientations or positions indicated by the terms “central”, “transverse”, “longitudinal”, “perpendicular”, “length”, “width”, “thickness”, “upper”, “lower”, “front”, “rear”, “left”, “right”, “vertical”, “horizontal”, “top”, “bottom”, “inner”, “outer”, “clockwise”, “counterclockwise”, “axial”, “radial”, “circumferential” are based on the orientations or positions shown in the figures, or the orientations or positions that the product of the present invention is commonly placed during use, or the orientations or positions that are commonly understood by those skilled in the art. They are merely for the convenience of describing and simplifying the description of the present invention, but not indicating or implying that the equipment or element referred to must have a specific orientation, or be constructed and operated in a specific orientation. Thus, they cannot be understood as a limitation of the present invention.

In addition, the terms “first” and “second” are used for descriptive purposes only and cannot be understood as the indication or implication of relative importance or the implication of the number of indicated technical features. Thus, a technical feature defined as “first” or “second” may explicitly or implicitly comprises one or more technical features. In the description of the present invention, unless it is clearly stated, “a plurality of” means two or more.

In the description of the present invention, unless it is clearly stated, the terms “installed”, “jointed”, “connected” and “fixed” shall be understood in a broad sense. For instance, it may be a fixed connection, a detachable connection, a mechanical connection, an electrical connection, a direct connection, an indirect connection through an intermediate medium, an internal connection of two components or an interaction between two components. For those skilled in the art, the specific meanings of the above terms in the present invention may be understood according to specific circumstances.

In the description of the present invention, unless it is clearly stated, the first feature being “above” or “below” the second feature may indicate that the first feature and the second feature are in direct contact or in indirect contact through other features between them. Moreover, the first feature being “on” or “above” the second feature may indicate that the first feature is directly above and obliquely above the second feature, or may simply indicate that the horizontal height of the first feature is higher than that of the second feature. The first feature being “below” the second feature may indicate that the first feature is directly below and obliquely below the second feature, or may simply indicate that the horizontal height of the first feature is lower than that of the second feature.

It should be noted that if an element is referred to as being “fixed to” or “arranged on” another element, it may be directly on another element or an intervening element exists. If an element is considered to be “connected” to another element, it may be directly connected to another element or an intervening element simultaneously exists. If there is an intervening element, the terms “vertical”, “horizontal”, “upper”, “lower”, “left” and “right” used in the present invention are for illustrative purposes only, which do not indicate that the present invention has only one embodiment.

It should be noted that the embodiments and features in the embodiments of the present invention may be combined with each other without conflict. Drawings and detailed embodiments are combined hereinafter to further elaborate the technical solution of the present invention.

Referring to FIGS. 1-5, the anti-loose mounting structure of the electric hair cutter fixed blade mounting frame comprises a body 1 and a cutter head assembly 2, wherein the cutter head assembly 2 is arranged at a front end of the body 1, and the cutter head assembly 2 further comprises a fixed blade mounting frame 21 and a fixed blade 22. The fixed blade 22 is fixedly connected to the fixed blade mounting frame 21, the front end of the body 1 is provided with a guide rail 11, and the fixed blade mounting frame 21 is slidably connected to the guide rail 11. An elastic member is arranged between the guide rail 11 and the fixed blade mounting frame 21, and the elastic member always imposes an elastic force on the fixed blade mounting frame 21. The direction of the elastic force is perpendicular to the sliding direction of the fixed blade mounting frame 21 along the guide rail 11, so that the fixed blade mounting frame 21 is always tightly attached to an inner side wall of the guide rail 11. The fixed blade mounting frame 21 is provided with a bent portion 211 extending inwards, the fixed blade mounting frame 21 interacts with the guide rail 11 in a sliding manner through the bent portion 211, and the elastic member abuts between the bent portion 211 and the guide rail 11. The elastic member is an arched elastic sheet 3.

Based on the aforesaid embodiment, the present invention provides the anti-loose mounting structure of the electric hair cutter fixed blade mounting frame, which comprises a body 1 and a cutter head assembly 2, wherein the cutter head assembly 2 is arranged at a front end of the body 1, and the cutter head assembly 2 further comprises a fixed blade mounting frame 21 and a fixed blade 22. The fixed blade 22 is fixedly connected to the fixed blade mounting frame 21, the front end of the body 1 is provided with a guide rail 11, and the fixed blade mounting frame 21 is slidably connected to the guide rail 11. An elastic member is arranged between the guide rail 11 and the fixed blade mounting frame 21, and the elastic member always imposes an elastic force on the fixed blade mounting frame 21. The direction of the elastic force is perpendicular to the sliding direction of the fixed blade mounting frame 21 along the guide rail 11, so that the fixed blade mounting frame 21 is always tightly attached to an inner side wall of the guide rail 11. The fixed blade mounting frame 21 is provided with a bent portion 211 extending inwards, the fixed blade mounting frame 21 interacts with the guide rail 11 in a sliding manner through the bent portion 211, and the elastic member abuts between the bent portion 211 and the guide rail 11. The elastic member is an arched elastic sheet 3. Through arranging the elastic member between the fixed blade mounting frame 21 and the guide rail 11, the elastic member always imposes an elastic force on the fixed blade mounting frame 21. The direction of the elastic force is perpendicular to the sliding direction of the fixed blade mounting frame 21 along the guide rail 11, so that the dimensional tolerance generated inevitably during production between the guide rail 11 and the fixed blade mounting frame 21 is compensated. In this way, when the fixed blade mounting frame 21 is mounted to the guide rail 11, the fixed blade mounting frame 21 is always tightly attached to the inner side wall of the guide rail 11, thereby preventing a gap from being generated between the fixed blade mounting frame 21 and the inner wall of the guide rail 11. The fixed blade mounting frame 21 operates stably, thus achieving the stable operation of the entire cutter head assembly 2 while avoiding loosening and tightening of the cutter head assembly 2 as well as noise generated during use. Thus, the operating performance of the electric hair cutter is significantly improved. During installation, the arched elastic sheet 3 is arranged in a groove 111, an arched portion 31 abuts against the bent portion 211, and a flat abutting portion 32 abuts against the inner side wall of the guide rail 11. The arched elastic sheet 3 allows the dimensional tolerance between the guide rail 11 and the fixed cutter mounting frame 21 to be compensated. Therefore, when the fixed blade mounting frame 21 is mounted to the guide rail 11, the bent portion 211 always abuts against the inner side wall of the guide rail 11, and the fixed blade mounting frame 21 does not loosen due to the dimensional tolerance between the guide rail 11 and the fixed cutter mounting frame 21. The stable operation of the fixed blade mounting frame 21 enables the whole cutter head assembly 2 to operate stably, so that the loosening and tightening of the cutter head assembly 2 as well as noise generated during use are avoided. Thus, the operating performance of the electric hair cutter is greatly enhanced.

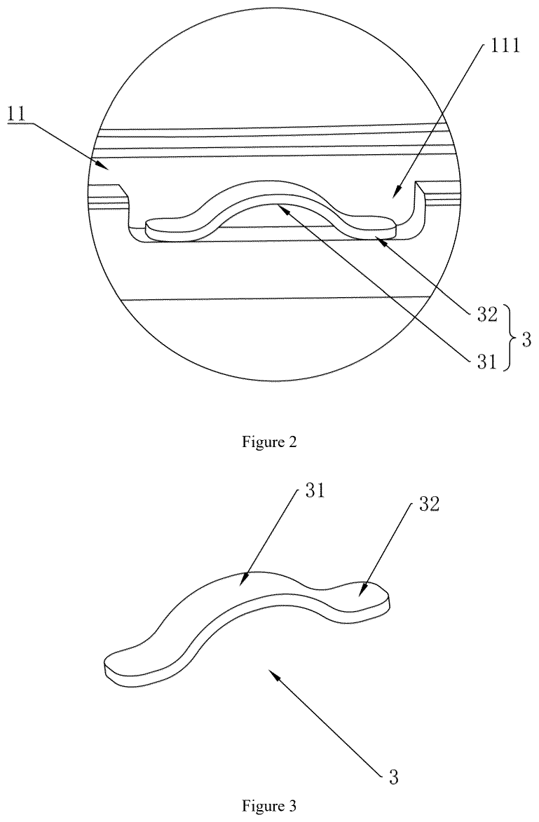

In another preferred embodiment, the arched elastic sheet 3 is provided with an arched portion 31, and both ends of the arched portion 31 extend to form a flat abutting portion 32. The arched portion 31 abuts against the fixed blade mounting frame 21, and the flat abutting portion 32 abuts against the inner side wall of the guide rail 11. The inner side wall of the guide rail 11 is provided with a groove 111 for interacting with the arched elastic sheet 3, and the arched elastic sheet 3 is installed in the groove 111 by means of the flat abutting portion 32. The length of the groove 111 is greater than the length of the arched elastic sheet 3, and the depth of the groove 111 is lower than the height of the arched elastic sheet 3. In this embodiment, the arched elastic sheet 3 may be arranged on the inner side wall of the guide rail 11, so that the bent portion 211 always possesses a tendency of abutting against the inner side wall of the guide rail 11. The arched elastic sheet 3 may also be arranged on the lower inner side wall of the guide rail 11, so that the bent portion 211 always possesses a tendency of abutting against the lower inner side wall of the guide rail 11. For instance, referring to FIG. 2, the arched elastic sheet 3 is arranged on the lower inner side wall of the guide rail 11, and the lower inner side wall of the guide rail 11 is provided with a groove 111 for allowing the arched elastic sheet 3 to be installed. The length of the groove 111 is greater than the length of the arched elastic sheet 3, thereby enabling the arched elastic sheet 3 to be placed in the groove 111. The depth of the groove 111 is lower than the height of the arched elastic sheet 3, and therefore, after being installed, the bent portion 211 interacts with the bottom of the groove 111 to compress and deform the arched elastic sheet 3. At this point, the arched elastic sheet 3 deforms to generate an elastic force, and the direction of the elastic force is perpendicular to the sliding direction of the fixed blade mounting frame 21 along the guide rail 11, so that the fixed blade mounting frame 21 is always tightly attached to the inner side wall of the guide rail 11. Thus, the bent portion 211 of the fixed blade mounting frame 21 always possesses the tendency of abutting against the lower wall of the guide rail 11. The fixed blade mounting frame 21 does not loosen even if the dimensional tolerance between the guide rail 11 and the fixed blade mounting frame 21 exists, and the cutter head assembly 2 operates smoothly, thereby significantly improving the stability of the electric hair cutter during use. In this embodiment, referring to FIGS. 2-3, the arrangement of the arched portion 31 makes the arched elastic sheet 3 deform when being compressed such that an elastic force is generated, and the arrangement of the flat abutting portion 32 allows the arched elastic sheet 3 to be conveniently and stably placed in the groove 111. Meanwhile, the contact area between the arched elastic sheet 3 and the bottom of the groove 111 is also increased, achieving the stable installation of the arched elastic sheet 3.

In another preferred embodiment of the present invention, one side of the body 1 is provided with an adjusting wrench for propelling the fixed blade mounting frame 21 to slide relative to the guide rail 11, and an elastic member is arranged on the other side of the body 1 corresponding to the adjusting wrench. In this embodiment, the adjusting wrench is capable of rotating relative to the body 1 and synchronously propelling the fixed blade mounting frame 21 to slide along the guide rail 11. The elastic member is located on the other side of the body 1 corresponding to the adjusting wrench, and because the fixed blade mounting frame 21 is limited by the screw when the adjusting wrench is installed, the bent portion 211 of the fixed blade mounting frame 21 on one side where the adjusting wrench is located does not shake during operation. The dimensional tolerance between the guide rail 11 and the fixed blade mounting frame 21 is compensated by installing the elastic member on the other side of the body 1 corresponding to the adjusting wrench. In this way, the two sides of the fixed blade mounting frame 21 do not shake during operation, and the fixed blade mounting frame 21 operates stably, enabling the cutter head assembly 2 to operate smoothly such that the operating performance of the electric hair cutter is significantly improved.

In another preferred embodiment of the present invention, the elastic member is made of a spring steel material. In this embodiment, the elastic member is made of the spring steel material. After undergoing the heat treatment and cold-drawing hardening, the spring steel material achieves high strength, high elastic limit, high yield limit, high flexibility and high plasticity such that the high elasticity of the elastic member is realized. The elastic force generated by the deformation of the elastic member makes the bent portion 211 always possess a tendency of abutting against the inner side wall of the guide rail 11.

Obviously, the above embodiments are merely examples for clear description and are not intended to limit the implementations of the present invention. For those skilled in the art, modifications or variations may be made on the basis of the above description. It is unnecessary and impossible to exhaustively list all implementations herein. The obvious modifications or variations made based on the above description shall fall into the scope defined by the claims of the present invention.

What is claimed is:

1. An anti-loose mounting structure of an electric hair cutter fixed blade mounting frame, comprising:
a body (1), and
a cutter head assembly (2), wherein the cutter head assembly (2) is arranged at a front end of the body (1), wherein the cutter head assembly (2) further comprises a fixed blade mounting frame (21) and a fixed blade (22), wherein the fixed blade (22) is fixedly connected to the fixed blade mounting frame (21), wherein the front end of the body (1) is provided with a guide rail (11), wherein the fixed blade mounting frame (21) is slidably connected to the guide rail (11), wherein an elastic member is arranged between the guide rail (11) and the fixed blade mounting frame (21), wherein the elastic member always imposes an elastic force on the fixed blade mounting frame (21), and wherein the direction of the elastic force is perpendicular to the sliding direction of the fixed blade mounting frame (21) along the guide rail (11), so that the fixed blade mounting frame (21) is always tightly attached to an inner side wall of the guide rail (11).

2. The anti-loose mounting structure of the electric hair cutter fixed blade mounting frame of claim 1, wherein the fixed blade mounting frame (21) is provided with a bent portion (211) extending inwards, wherein the fixed blade mounting frame (21) interacts with the guide rail (11) in a sliding manner through the bent portion (211), and wherein the elastic member abuts between the bent portion (211) and the guide rail (11).

3. The anti-loose mounting structure of the electric hair cutter fixed blade mounting frame of claim 1, wherein the elastic member is an arched elastic sheet (3).

4. The anti-loose mounting structure of the electric hair cutter fixed blade mounting frame of claim 3, wherein the arched elastic sheet (3) is provided with an arched portion (31), wherein both ends of the arched portion (31) extend to form a flat abutting portion (32), wherein the arched portion (31) abuts against the fixed blade mounting frame (21), and wherein the flat abutting portion (32) abuts against the inner side wall of the guide rail (11).

5. The anti-loose mounting structure of the electric hair cutter fixed blade mounting frame of claim 4, wherein the inner side wall of the guide rail (11) is provided with a groove (111) for interacting with the arched elastic sheet (3), and wherein the arched elastic sheet (3) is installed in the groove (111) by means of the flat abutting portion (32).

6. The anti-loose mounting structure of the electric hair cutter fixed blade mounting frame of claim 5, wherein the length of the groove (111) is greater than the length of the arched elastic sheet (3), and wherein the depth of the groove (111) is lower than the height of the arched elastic sheet (3).

7. The anti-loose mounting structure of the electric hair cutter fixed blade mounting frame of claim 1, wherein one side of the body (1) is provided with an adjusting wrench for propelling the fixed blade mounting frame (21) to slide relative to the guide rail (11), and wherein an elastic member is arranged on the other side of the body (1) corresponding to the adjusting wrench.

8. The anti-loose mounting structure of the electric hair cutter fixed blade mounting frame of claim 1, wherein the elastic member is made of a spring steel material.
